(19) United States
(12) Patent Application Publication
(10) Pub. No.: US 2007/0234079 A1
(43) Pub. Date: Oct. 4, 2007

(54) INFORMATION PROCESSING DEVICE, POWER SUPPLY CONTROL METHOD AND STORAGE MEDIUM

(75) Inventors: Masatoshi KIMURA, Kawasaki (JP); Kazuhiro Takeda, Kawasaki (JP); Yasuhiro Mikasa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/460,718

(22) Filed: Jul. 28, 2006

(30) Foreign Application Priority Data
Mar. 29, 2006 (JP) 2006-092516

(51) Int. Cl. G06F 1/00

(52) U.S. Cl. 713/300

(57) ABSTRACT

An information processing device includes: a power-off detection unit for detecting a signal relating to a power-off operation of a user; an application program termination unit for terminating a predetermined application program when the power-off operation is performed; and a control unit for passing control, after the termination of the application program, to a state in which normal execution can be started faster than normal power-off, and power consumption is lower than in the normal execution.

### BACKGROUND OF THE INVENTION

1. Field of the Invention

The present invention relates to a technique of starting and terminating an information processing device.

2. Description of the Related Art

When an information processing device such as a PC, etc. is once terminated and then restarted, there are various problems such as performing a resume function at the restart, etc. as disclosed by the patent document 1 (Japanese Published Patent Application No. H10-293619) and the patent document 2 (Japanese Published Patent Application No. H7-271561).

Relating to these problems, the restart time from power-up is very important for an information processing device that has been widely used as AV equipment loaded with a television tuner, etc. When the information processing device is used as AV equipment, it is necessary, as with ordinary AV equipment, to be available immediately after power-up.

As an information processing device which is loaded with the above-mentioned television tuner and can be used as AV equipment, the patent document 3 (Japanese Published Patent Application No. H10-320094) discloses an information processing device capable of switching between a TV mode in which a user can watch full-screen TV images and a PC mode using Windows.

As described above, it is necessary for an information processing device, which is loaded with a television tuner, etc., and can be used as AV equipment, to be able to start in a short time as common AV equipment at power-up.

To solve the above-mentioned problem, there has been a method of loading an information processing device with an OS for integration in addition to an OS for using the device as a PC, starting the information processing device by the OS for integration when the device is used as AV equipment after power-up, thereby quickly starting the device.

However, with the configuration of loading the information processing device with two OS's, the entire device is expensive, and each OS requires an application program to be individually developed. Thus, excess development is required. Additionally, it is a laborious process to use a PC and AV equipment in cooperation, and it is also difficult to unify the application programs to be used.

### SUMMARY OF THE INVENTION

To solve the above-mentioned problems, the present invention aims at providing an information processing device and a program capable of starting the device within a short time without loading it with two OS's.

To attain the above-mentioned objective, the information processing device according to the present invention includes a power-off detection unit, an application program termination unit, and a control unit.

The power-off detection unit detects a signal relating to the power-off operation of a user.

The application program termination unit terminates a predetermined application program when the power-off operation is performed.

After the termination of the application program, the control unit passes control to a state in which the normal execution can be started faster than the normal power-off, and the power consumption can be lower than in the normal execution.

With the above-mentioned configuration, the application program with which the information processing device is started faster than the normal power-off and the power consumption is lower than in the normal execution terminates.

The control unit can be constituted to further include an application program activation unit for starting a predetermined application program before passing control to the above-mentioned state.

Thus, when control is returned from the state in which the normal execution can be started faster than the normal power-off, and the power consumption can be lower than in the normal execution, control can be returned to the state in which the predetermined application program is started.

Furthermore, a power supply state indicator can be turned off when control is passed to the above-mentioned state.

With the above-mentioned configuration, the power supply LED can be turned off and the user can recognize it as the shutdown status although the normal execution can be started faster than the normal power-off, and the power consumption can be lower than in the normal execution.

In addition, the control unit can make a correction to perform a normal terminating process when the user performs a power-off operation different from the above-mentioned power-off operation.

With the above-mentioned configuration, the contents of the terminating process can be changed depending on the method of the power-off operation performed by a user.

The information processing device according to the present invention available using a plurality of accounts can also be constituted by including: a power-off detection unit for detecting a signal relating to the power-off operation of a user; an account change processing unit for stopping the use by an account of the user when the power-off operation is performed, and making a change to the use by an account for a high-speed start; and a control unit for passing control to a state in which the normal execution can be started faster than the normal power-off, and the power consumption can be lower than in the normal execution after the termination of the application program.

The present invention includes in its scope the power supply control method and program for use with the information processing device.

According to the present invention, the device can be started in a show time without loading it with two OS's.

When entering a suspended state, a started application program is terminated. Therefore, although the user turns off or pull the plug of the body of the information processing device by mistakenly recognizing that the OS has been shut down, the device can be restarted without problems.

### BRIEF DESCRIPTION OF THE DRAWINGS

FIGS. 1A and 1B are timing charts showing the operation to be performed when the button of a remote control is pressed in the information processing device according to a mode for embodying the present invention;

FIG. 2 is a flowchart of the operations of the information processing device performed when the termination is performed by pressing the power supply button of the remote control;

FIG. 3 is a flowchart of the operating process performed when the information processing device returns;

FIG. 4 shows an example of the display screen displayed when the information processing device returns;

FIG. 5 shows an example of the configuration of the information processing device; and

FIG. 6 shows an example of a storage medium.

### DESCRIPTION OF THE PREFERRED EMBODIMENT

A mode for embodying the present invention is explained below by referring to the attached drawings.

It is assumed that the information processing device according to the mode for embodying the present invention is provided with one OS. When a user turns the power supply switch to the OFF position, the OS is not shut down, but the suspended state in which the current is not supplied to the components other than the memory is entered.

At this time, the display screen, etc. is displayed to indicate as if the OS were shut down. Furthermore, all application programs other than the resident activated applications are terminated before entering the suspended state to that there occur no problems although the power supply is shut off by pressing the power supply button. The application programs to be terminated and the application programs not to be terminated are predetermined and stored in the auxiliary storage device, etc.

Thus, since the device can be started from the suspended state when it is activated, a high-speed activation can be realized. Since the application program has been terminated before entering the suspended state, there occur no problems when the device is restarted although the user mistakenly considers that the device is shut down and turn off the body of the information processing device or pulls the plug of the device after entering the suspended state by turning the switch of the remote control to the off position.

Furthermore, since there is only one OS provided for the device, it can be constituted at a lower cost as compared with the case where two OS's are provided. In addition, excess development for an application program is not required, and the cooperation between AV equipment and a PC can be easily performed.

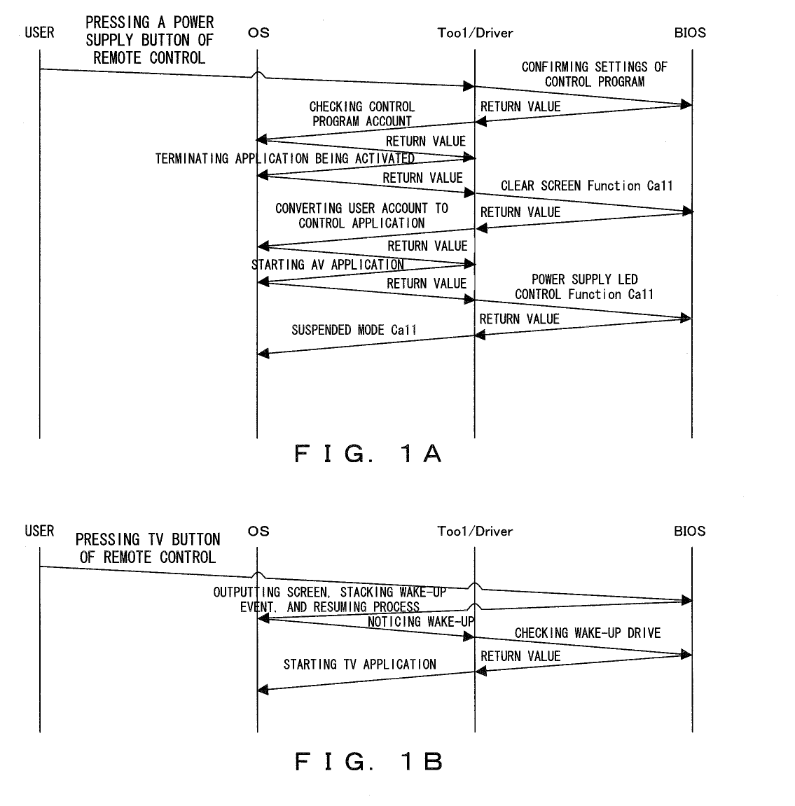

FIG. 1 shows a timing chart showing the operation to be performed when the button of a remote control is pressed in the information processing device according to a mode for embodying the present invention.

FIG. 1A shows the operation performed when the information processing device is terminated using a power supply switch of a remote control. FIG. 1B shows the operation performed when the TV switch of the remote control is pressed for the information processing device in the suspended state by the operation shown in FIG. 1A.

In FIG. 1A, when the user presses the power supply of the remote control, the power supply control program requests the confirmation of setting the BIOS (basic input output system) If a response value indicates the setting of using the power supply control program, then the power supply control program requests the OS to check the current account name and receives a response.

Then, the power supply control program determines an application to be terminated according to the information stored in the auxiliary storage device from among the currently activated application programs for the OS, issues a command to terminate the determined application, and receives a response. In addition, the program issues a function call to the BIOS to turn off the display screen of the information processing device.

If the information processing device has a plurality of accounts, there is the possibility that the operator who has turned the power supply switch to the on position uses the environment of the account used when the power-off operation is performed. Therefore, the power supply control program instructs the OS to change the account of the current OS which is set as the user account to its own account.

Then, the power supply control program performs control to turn off the power supply LED on the BIOS using the function call. When it terminates it starts the AV application as a starting launcher of the AV application program with the screen turned off, and then controls the OS to enter the suspended mode.

In this state, the information processing device looks to the user as if the OS were shut down, and terminated.

In this state, when the TV button of the remote control is pressed, the event is stacked in the BIOS as shown in FIG. 1B. The BIOS also turns on the display screen, displays the screen of the AV application, returns the OS, and notifies the power supply control program of the event. Thus, the power supply control program recognizes that the TV button of the remote control has been pressed.

Then, the OS notifies the application of the activation of the OS as wake-up. Upon receipt of the notification, the device driver performs an initializing process. The power supply control program asks the BIOS what has started the wakeup device check, and activates the TV application if, as a response, the activation was performed by pressing the TV button of the remote control.

Thus, in the information processing device according to the present mode for embodying the present invention, when the power supply button of the remote control is pressed, it looks as if the shutdown process were performed, thereby entering the suspended state. At this time, all application programs being activated are closed. When the device is restarted, it can be activated from the suspended state.

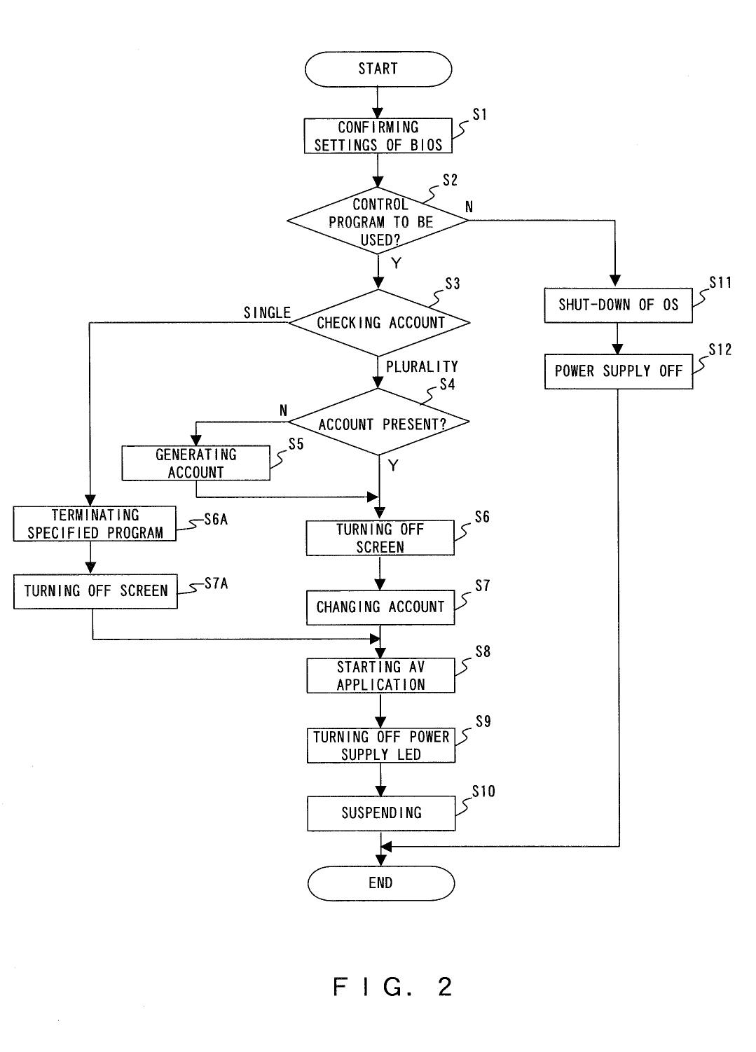

FIG. 2 is a flowchart of the operating process performed when the information processing device is terminated by pressing the power supply button of the remote control.

The process shown in FIG. 2 is realized by the CPU in the information processing device executing the program stored in the memory.

When the power supply button of the remote control is pressed, the settings of the BIOS are confirmed in step S1. Based on the result, it is determined whether or not the settings indicate using the power supply control program. If the settings indicate not using the power supply control program (NO in step S2), then the OS is shut down in step S11, and the power supply is OFF in step S12, thereby terminating the present process.

If the settings indicate using the power supply control program in step S2 (YES in step S2), the account of the OS is checked in step S3.

If the OS has a plurality of accounts (plurality of accounts in step S3), and the account of the power supply control program is registered in the OS (YES in step S4), then control is passed to step S6. If the account of the power supply control program is not registered in the OS (NO in step S4), then the account of the power supply control program is generated in the OS in step S5.

Then, in step S6, the display screen of the information processing device is turned off. In step S7, as security means, the account of the current user is changed to the account of the power supply control program.

If the OS has a single account only (single in step S3), then a specific application program to be terminated is determined according to predetermined information, and the terminating process is performed (step S6A) Then, the display screen of the information processing device is turned off (step S7A).

Then, in the state in which the display screen is turned off, the AV application is started (step S8). In step S9, the power supply LED of the information processing device is turned off. Finally, the device enters the suspended state.

In the above-mentioned process, the information processing device is in the suspended state, but looks to the user as if the OS were shut down and the power supply were OFF. Since the activated application program enters the suspended state after the termination, there occur no problems when the device is restarted although the body of the information processing device is turned off or its plug is pulled.

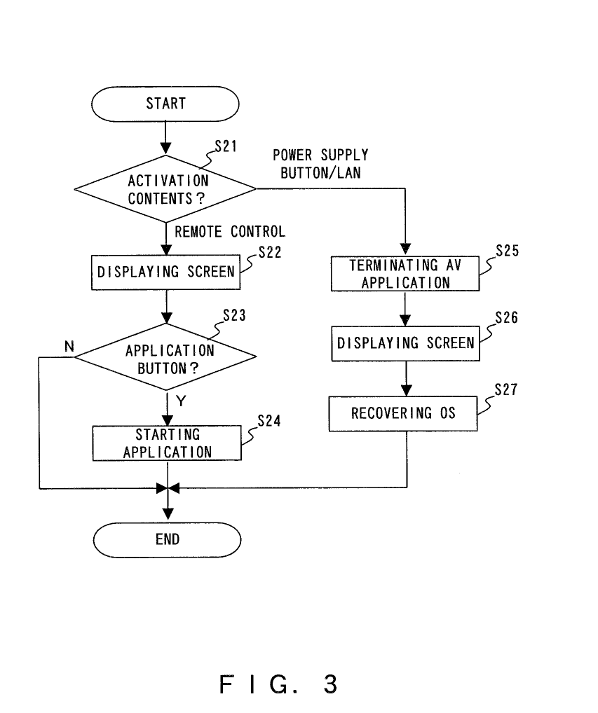

FIG. 3 is a flowchart of the operating process when the information processing device which has terminated in the process shown in the flowchart in FIG. 2 recovers.

The process shown in FIG. 3 is also realized by the CPU of the information processing device executing the program stored in the memory.

When the process shown in FIG. 3 is started, it is checked what instructed the BIOS to start the device in step S21.

As a result, if a start instruction has been issued by a press of a power supply button of the information processing device or a notification through a LAN (power supply button/LAN in step S21), then the AV application terminates in the state in which the display screen of the information processing device is turned off in step S25. The screen is displayed in step S26. The OS recovers in step S27. Then, the present process terminates.

In step S21, if a start instruction is issued by a press of an operation button of the remote control (remote control in step S21), then the turned off display screen of the information processing device is displayed in step S22.

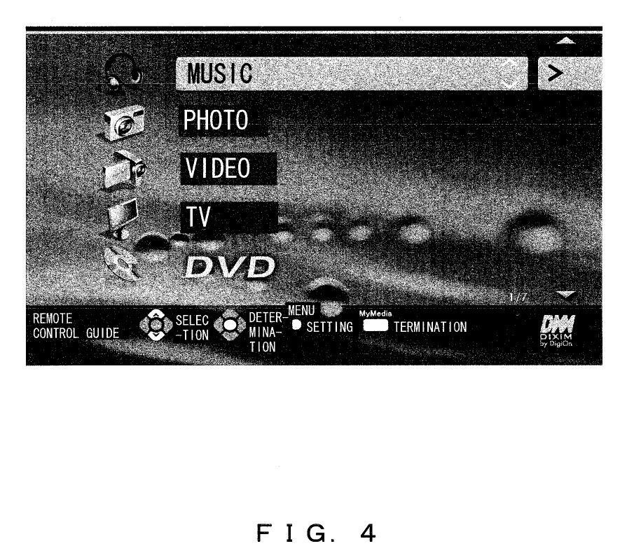

FIG. 4 shows a display screen displayed on the information processing device at this time. Since the AV application has been started before the information processing device enters the suspended state, the device displays the display screen of the AV application. Thus, since the information processing device is started in the state in which the AV application as a launcher program of the AV application program is started, the application program such as a TV application, etc. can be started immediately after the application.

In step S23, if the pressed button of the remote control is a button for specification of an application such as a TV button, etc. (YES in step S23), then the application program corresponding to the pressed button is started in step S24, and the process terminates. If the pressed button of the remote control is not the one for specification of an application (NO in step S23), the present process terminates as is.

Thus, according to the information processing device of the mode for embodying the present invention, the device can be started from the suspended state, thereby realizing high speed activation.

In addition, according to the information processing device of the mode for embodying the present invention, the operation of changing to the suspended state in response to the power-off is indicated. However, in addition to the suspended state, the state in which the normal execution can be started faster than the normal power-off, and the power consumption can be lower than in the normal execution can also be entered. For example, the contents of the memory can be recorded in the storage device, and power supply to each component can be terminated. Furthermore, unused equipment, for example, the display device and the storage device can be turned off.

Additionally, in the mode for embodying the present invention, the operation of changing into a suspended state in response to the power-off operation by the remote control is described. However, if the all power supply OFF process is suspended, the operation of the information processing device can be faulty. The power supply OFF operation other than the remote control OFF operation can be normally terminated.

Described below is the configuration of the information processing device.

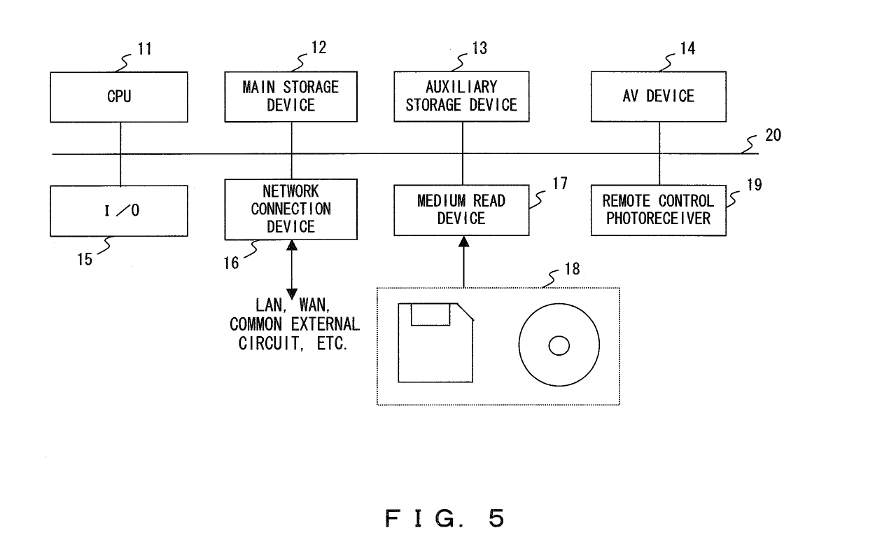

FIG. 5 is a block diagram of the rough configuration of the information processing device according to the mode for embodying the present invention.

The information processing device shown in FIG. 5 has a remote control photoreceiver 19 for receiving a radio directive from a CPU 11, a main storage device 12 such as RAM, etc., an auxiliary storage device 13 such as a hard disk, etc., an AV device 14 such as a TV tuner, etc., an input/output device (I/O) 15, a network connection device 16 such as a modem, etc., a medium read device 17 for reading storage contents from a portable storage medium such as a magnetic tape, etc., and notifying the CPU 11 of the received radio directive. The above-mentioned components are connected via a bus 20. Each component communicates data with each other via the bus 20.

The CPU 11 reads the program on the auxiliary storage device 13 to the main storage device 12 as a resident program, and executes the program using the main storage device 12 as work memory, thereby realizing the process of the flowchart shown in FIGS. 2 and 3.

In the information processing device shown in FIG. 5, a medium read device 26 reads a program and data stored in a storage medium 28 such as a magnetic tape, a flexible disk, CD-ROM, MO, etc., and downloads them into a main storage device 22 or an auxiliary storage device 23. By a CPU 21 executing and using the program and the data, the processes according to the flowcharts shown in FIGS. 2 and 3 can be realized as software.

In the information processing device shown in FIG. 5, application software can be switched using a storage medium 18 such as a flexible disk. Therefore, the present invention is not limited to the information processing device or the method of controlling the start/termination of the device, but can be constituted as a computer-readable storage medium 18 used to direct a computer to perform the function of the mode for embodying the present invention when used by the computer.

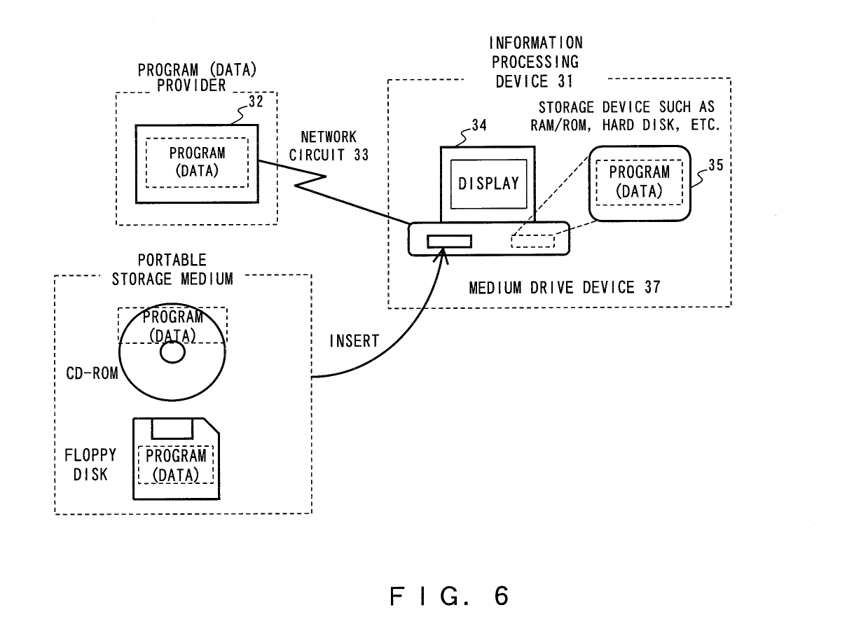

In this case, the “storage medium” includes a portable storage medium 36 removable from a medium drive device 37 such as CD-ROM, a flexible disk (or an MO, a DVD, a removable hard disk, etc.), etc., a storage unit (database, etc.) 32 in an external device (server, etc.) transmitted via a network circuit 33, memory (RAM, hard disk, etc.) 35 in a body 34 of an information processing device 31, etc. as shown in FIG. 6. The program stored in the portable storage medium 36 and the storage unit (database, etc.) 32 is loaded into the memory (RAM of hard disk, etc.) 35 in the body 34, and then executed.

In addition to the examples described above, for example, various large-capacity storage media including next-generation optical disk storage media using a blue laser such as Blu-ray Disc (registered trademark), AOD (advanced optical disc), etc., an HD-DVD 9, a blue laser DVD, etc. using a blue purple laser can be used as the storage media such as the above-mentioned CD-ROM, DVD-ROM, etc. in embodying the present invention.

What is claimed is:

1. An information processing device, comprising:
a power-off detection unit detecting a signal relating to a power-off operation of a user;
an application program termination unit terminating a predetermined application program when the power-off operation is performed; and
a control unit passing control, after the termination of the application program, to a state in which normal execution can be started faster than normal power-off, and power consumption is lower than in the normal execution.

2. The device according to claim 1, further comprising
an application program activation unit for starting a predetermined application program before the control unit passes control to the state.

3. The device according to claim 1, wherein
a power supply state indicator is turned off when control is passed to the state.

4. The device according to claim 1, wherein the control unit performs a normal terminating process when the user performs a power-off operation different from said power-off operation.

5. An information processing device available using a plurality of accounts, comprising:
a power-off detection unit detecting a signal relating to power-off operation of a user;
an account change processing unit stopping a use by an account of the user when the power-off operation is performed, and making a change to a use by an account for a high-speed start; and
a control unit passing control to a state in which normal execution is started faster than normal power-off, and power consumption is lower than in the normal execution after terminating the application program.

6. The device according to claim 5, further comprising
an application program activation unit for starting a predetermined application program before the control unit passes control to the state.

7. The device according to claim 5, wherein
a power supply state indicator is turned off when control is passed to the state.

8. The device according to claim 5, wherein
the control unit performs a normal terminating process when the user performs a power-off operation different from said power-off operation.

9. A power supply control method, comprising:
detecting a signal relating to power-off operation of a user;
terminating a predetermined application program when the power-off operation is performed; and
passing control to a state in which normal execution is started faster than normal power-off, and power consumption is lower than in the normal execution after terminating the application program.

10. The method according to claim 9, further comprising an application program activating step of starting a predetermined application program before passing control to the state in the control step.

11. The device according to claim 9, wherein
a power supply state indicator is turned off when control is passed to the state.

12. The method according to claim 9, wherein
The control step performs a normal terminating process when a power-off operation different from said power-off operation is received.

13. A power supply control method for an information processing device available using a plurality of accounts, comprising:
detecting a signal relating to power-off operation of a user;
stopping a use by an account of the user when the power-off operation is performed, and making a change to a use by an account for a high-speed start; and
passing control to a state in which normal execution is started faster than normal power-off, and power consumption is lower than in the normal execution after terminating the application program.

14. The method according to claim 13, further comprising
an application program activating step of starting a predetermined application program before passing control to the state in the control step.

15. The method according to claim 13, wherein
a power supply state indicator is turned off when control is passed to the state.

16. The device according to claim 13, wherein
a normal terminating process is performed when a power-off operation different from said power-off operation is received.

17. A computer-readable storage medium storing a program used to direct a computer to perform:
detecting a signal relating to power-off operation of a user;
terminating a predetermined application program when the power-off operation is performed; and
passing control to a state in which normal execution is started faster than normal power-off, and power consumption is lower than in the normal execution after terminating the application program.

18. The storage medium according to claim 17 storing a program used to direct a computer to further perform
starting a predetermined application program before passing control to the state in the control step.

19. A computer-readable storage medium storing a program used to direct a computer available using a plurality of accounts to perform:
detecting a signal relating to power-off operation of a user;
stopping a use by an account of the user when the power-off operation is performed, and making a change to a use by an account for a high-speed start; and
passing control to a state in which normal execution is started faster than normal power-off, and power consumption is lower than in the normal execution after terminating the application program.

20. The storage medium according to claim 19 storing a program used to direct a computer to further perform
starting a predetermined application program before passing control to the state.
